(19) United States
(12) Patent Application Publication
(10) Pub. No.: US 2026/0062216 A1
(43) Pub. Date: Mar. 5, 2026

(54) Transport Facility

(71) Applicant: Daifuku Co., Ltd., Osaka-shi (JP)

(72) Inventor: Yosuke Fujiwara, Komaki-shi (JP)

(21) Appl. No.: 19/317,266

(22) Filed: Sep. 3, 2025

(30) Foreign Application Priority Data
Sep. 5, 2024 (JP) 2024-152954

(51) Int. Cl. B65G 1/06; B66B 9/00; B66C 19/00; G05D 1/244; G05D 105/28; H01L 21/677

(52) U.S. Cl. CPC B65G 1/065; B66B 9/00; B66C 19/00; G05D 1/244; G05D 2105/28

(57) ABSTRACT

A transport facility equipped with an overhead transport vehicle, a ground transport vehicle, and a transport device includes a transfer section for an article to be transferred between the overhead transport vehicle and the transport device, the transfer section being on the upper side of a floor surface and separated from the floor surface. The overhead transport vehicle and the ground transport vehicle are configured to directly transfer an article therebetween, and the ground transport vehicle and the transport device are configured to transfer an article therebetween via the overhead transport vehicle and the transfer section.

### CROSS-REFERENCE TO RELATED APPLICATION

This application claims priority to Japanese Patent Application No. 2024-152954 filed Sep. 5, 2024, the disclosure of which is hereby incorporated by reference in its entirety.

### BACKGROUND OF THE INVENTION

### 1. Field of the Invention

The present invention relates to a transport facility for transporting articles.

### 2. Description of Related Art

JP 2020-184567A discloses a transport facility for transporting articles that is equipped with a plurality of different transport devices (In the Description of the Related Art, the reference numerals in parentheses are those used in the reference document). These transport devices include a ground transport vehicle (411) configured to travel on the ground, an overhead transport vehicle (511) configured to travel along overhead transport rails (5), and a loading and unloading device (338) configured to transfer articles between the ground transport vehicle (411) and the overhead transport vehicle (511).

Using two types of transport carriers, namely the ground transport vehicle and the overhead transport vehicle, can be expected to increase transport efficiency in the transport facility. In this transport facility, however, the loading and unloading device for transferring articles between the ground transport vehicle and the overhead transport vehicle is installed on the floor surface. The installation of the loading and unloading device is likely to narrow the floor area in the transport facility. Also, the narrowed floor area may limit the travelable region for the ground transport vehicle. Therefore, there is room to improve space utilization efficiency in the transport facility.

### SUMMARY OF THE INVENTION

In view of the foregoing background, it is desired to further improve transport efficiency in a transport facility for transporting articles that uses at least a ground transport vehicle and an overhead transport vehicle.

In view of the above, a transport facility includes: an overhead transport vehicle configured to travel on a track held by a ceiling of the transport facility and transport an article; a ground transport vehicle configured to travel on a floor surface and transport an article; a transport device configured to transport an article along a transport path different from a transport path of the overhead transport vehicle and from a transport path of the ground transport vehicle; and a transfer section for an article to be transferred between the overhead transport vehicle and the transport device, the transfer section being above the floor surface and separated from the floor surface, the overhead transport vehicle and the ground transport vehicle being configured to directly transfer an article therebetween, the ground transport vehicle and the transport device being configured to transfer an article therebetween via the overhead transport vehicle and the transfer section.

According to this configuration, the article can be transferred between the overhead transport vehicle and the ground transport vehicle, not via the transfer section. This eliminates the need for providing a transfer section on the floor surface. The transfer section is used to transfer the article between the overhead transport vehicle and the transport device. Here, the transfer section is disposed above the floor surface and is separated therefrom, so that it is not necessary to secure a space for providing a transfer section on the floor surface. Accordingly, this configuration makes it easier to improve the space utilization efficiency in the transport facility for transporting the article with use of at least the ground transport vehicle and the overhead transport vehicle.

Further features and advantages of the transport facility will be apparent from the following description of exemplary and non-limiting embodiments described with reference to the drawings.

### BRIEF DESCRIPTION OF THE DRAWINGS

FIG. 1 is a plan view of an example of a transport facility.

FIG. 2 shows an example of an overhead transport vehicle.

FIG. 3 shows an example of a ground transport vehicle.

FIG. 4 shows an example of a mode of moving an article.

FIG. 5 shows another example of the mode of moving an article.

### DESCRIPTION OF THE INVENTION

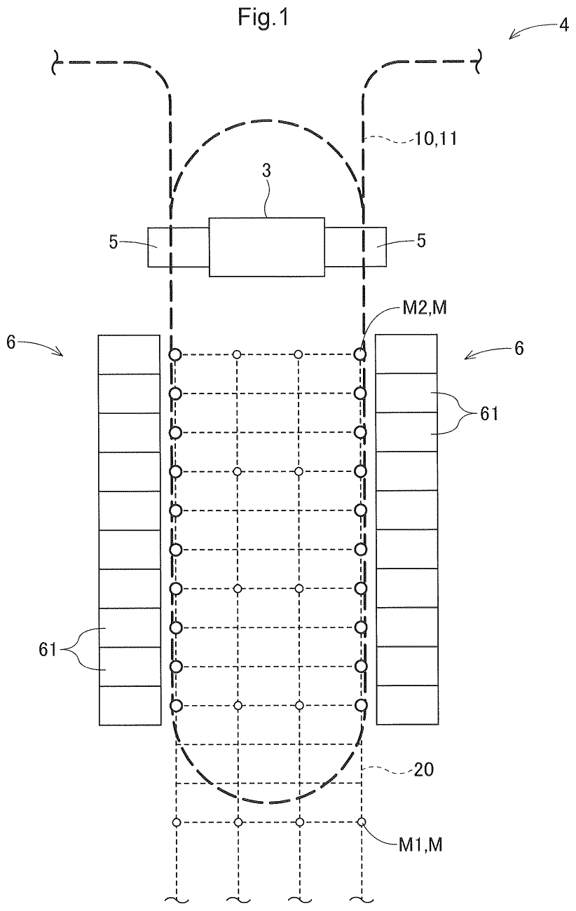

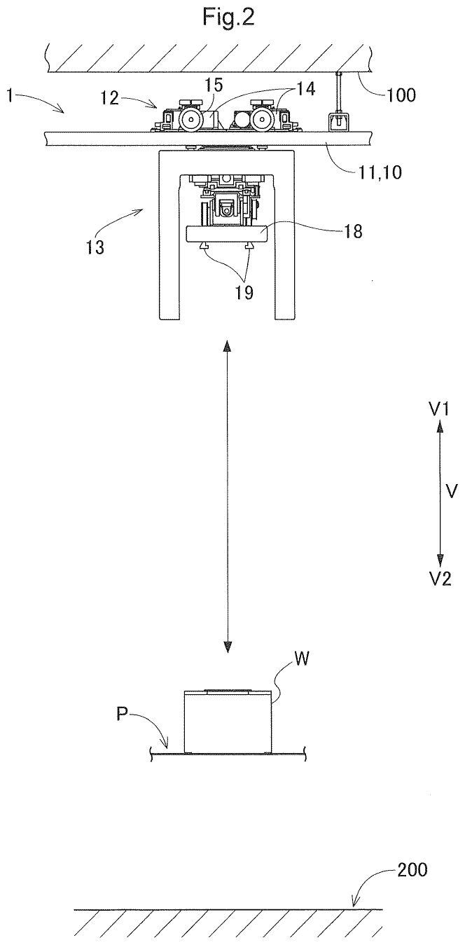

Hereinafter, an embodiment of a transport facility is described with reference to the drawings. FIG. 1 is a plan view of an example of a transport facility 4. The transport facility 4 includes an overhead transport vehicle 1, a ground transport vehicle 2, and an inter-floor transport device 3 (transport device), as automatic transport machines for moving articles W (see FIG. 2 and other figures). That is, the transport facility 4 includes a first automatic transport machine (overhead transport vehicle 1), a second automatic transport machine (ground transport vehicle 2), and a third automatic transport machine (inter-floor transport device 3). Here, “to move” includes: (i) a case where the overhead transport vehicle 1, the ground transport vehicle 2, and the inter-floor transport device 3 move the article W independently (i.e., “to transport”); (ii) a case of moving the article W between the automatic transport machines (i.e., “to transfer”); and (iii) a case of moving the article W between a target location (e.g., later-described transfer section 5 or storage device 6) that is fixedly provided in the transport facility 4 and any of the automatic transport machines (i.e., “to transfer”). In addition, the present embodiment illustrates a front opening unified pod (FOUP) for containing semiconductor wafers as an example of the article W, but the article W is not limited to an FOUP.

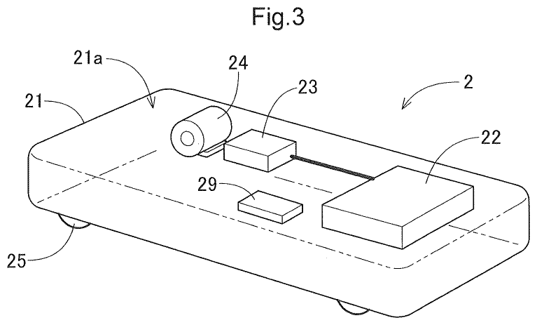

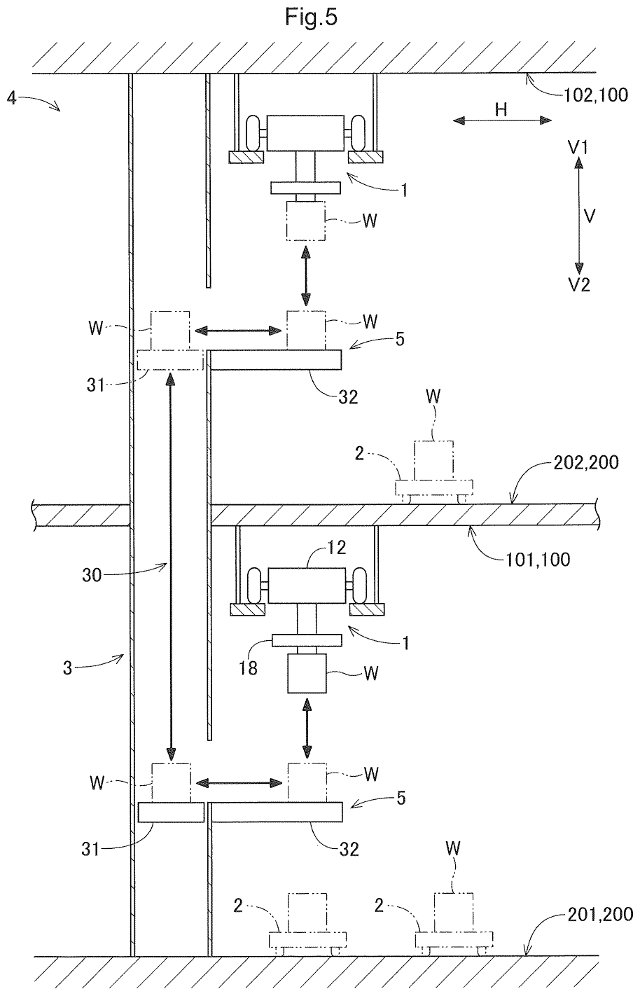

The overhead transport vehicle 1 holds the article W in a suspending manner and travels along travel rails 11 (track) supported by a ceiling 100 to transport the article W, as shown in FIG. 2. The ground transport vehicle 2 travels on a floor surface 200 to transport the article W. The ground transport vehicle 2 transports the article W placed on a top surface, which functions as a placement section 21a, of a carrier unit 21 shown in FIG. 3, in which the article Wis omitted. The inter-floor transport device 3 is a transport device for transporting the article W along a transport path 30 (see FIG. 5), which is different from transport paths of the overhead transport vehicle 1 and the ground transport vehicle 2. The transport facility 4 in the present embodiment has multiple stories (two stories in this example) as shown in FIG. 5, and the inter-floor transport device 3 transports the article W along the up-down direction V between different stories.

The transport facility 4 is provided with transfer sections 5 for transferring the article W between the overhead transport vehicle 1 and the inter-floor transport device 3, as shown in FIG. 5. The transfer section 5 is located on the upper side V1 of the floor surface 200 and is separated from the floor surface 200. Each transfer section 5 is disposed such that its lowermost portion (portion on the lower side V2) is separated from the corresponding floor surface 200, not in contact with the floor surface 200. Thus, the transfer section 5 is located at a height that at least allows the ground transport vehicle 2 with the article W placed thereon to travel on the lower side V2 of the transfer section 5. It is also preferable that the transfer section 5 is located at a height that allows an operator (not shown) present on the floor surface 200 to pass through the lower side V2 of the transfer section 5 and work on the lower side V2 of the transfer section 5. For example, it is preferable that the transfer section 5 is located on the upper side V1 of the floor surface 200, about three meters away from the floor surface 200. Although details will be described later, an entry-exit section 32 of the inter-floor transport device 3 corresponds to the transfer section 5 in the present embodiment.

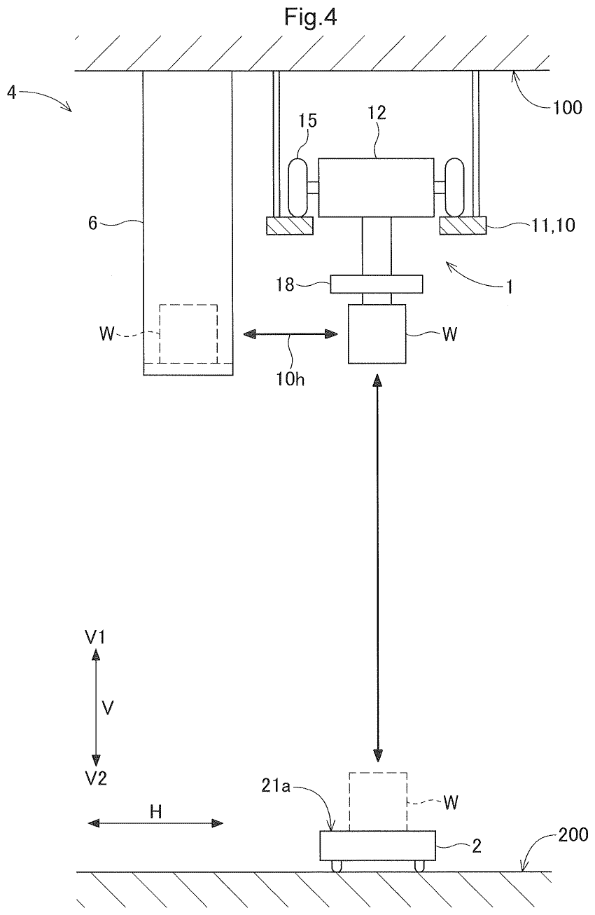

The article W can be directly transferred between the overhead transport vehicle 1 and the ground transport vehicle 2, as shown in FIG. 4. On the other hand, the transfer section 5 (entry-exit section 32) is separated from the floor surface 200 to the upper side V1, so that the article W cannot be directly transferred between the ground transport vehicle 2 and the inter-floor transport device 3. In the transport facility 4, the article W is transferred between the ground transport vehicle 2 and the inter-floor transport device 3 via the overhead transport vehicle 1 and the entry-exit section 32 (transfer section 5). That is, the article W is transferred between the ground transport vehicle 2 and the inter-floor transport device 3 by transferring the article W between the entry-exit section 32 (transfer section 5) of the inter-floor transport device 3 and the overhead transport vehicle 1 as shown in FIG. 5, and transferring the article W between the overhead transport vehicle 1 and the ground transport vehicle 2 as shown in FIG. 4.

Using two automatic transport machines, namely the ground transport vehicle 2 and the overhead transport vehicle 1, makes it easy to increase the efficiency of transporting the article W in the transport facility 4. However, if the transfer section 5 is installed on the floor surface 200, the effective floor area in the transport facility 4 will become smaller for the installation of the transfer section 5. If the narrower floor area limits the travelable region for the ground transport vehicle 2, the improvement in transporting efficiency will be limited. This impact is likely to be more significant if the area of the site where the transport facility 4 is installed is narrower. In the present embodiment, the article is not directly transferred between the ground transport vehicle 2 and the entry-exit section 32 (transfer section 5) of the inter-floor transport device 3. Thus, it is not necessary to provide the transfer section 5 on the floor surface 200, making effective utilization of the floor surface 200 easy. For example, it is easy to increase space efficiency and improve transport efficiency when constructing the transport facility 4 on a limited site area.

Example configurations of the overhead transport vehicle 1, the ground transport vehicle 2, and the inter-floor transport device 3 are described below. As shown in FIGS. 2, 4, and 5, as well as other figures, the overhead transport vehicle 1 includes a travel unit 12 that travels along an overhead travel path 10 while being guided by a pair of travel rails 11, which is a track supported in a suspended manner from the ceiling along a travel path (overhead travel path 10), and a main body 13 that is located on the lower side V2 of the travel rails 11 and supported in a suspended manner by the travel unit 12. The overhead transport vehicle 1 is supported by the travel rails 11 and operates with driving power supplied in a contactless manner from a power supply line (not shown) routed along the overhead travel path 10. The main body 13 includes an article holder 18 capable of moving up and down relative to the main body 13 and configured to grip the article W with a gripper 19 and hold the article W in a suspended state. The overhead transport vehicle (overhead hoist transport vehicle) 1 grips and suspends the article W placed at a transfer position P by using the gripper 19, travels while holding the article W in a suspended manner to transport the article W, and transfers the article W to another transfer position P.

The travel unit 12 includes a pair of travel wheels 15 that are driven to rotate by a travel motor 14. The travel wheels 15 roll on a traveling surface on the upper surfaces of the respective travel rails 11. In addition to the travel motor 14, the main body 13 includes an actuator for moving the article holder 18 up and down, an actuator for driving the gripper 19 for gripping the article W, and the like, as well as drive circuits and the like for these actuators (all of which are not shown).

Examples of the ground transport vehicle 2 include an automatic guided vehicle (AGV), a transport carrier with a sorting function, a transport robot, and an autonomous mobile robot (AMR). The present embodiment illustrates, for simplicity, an example of a transport carrier for transporting the article W placed thereon, as shown in FIG. 4.

The transparent perspective view in FIG. 3 schematically shows an example of the ground transport vehicle 2. As mentioned above, the present embodiment illustrates a transport carrier constituted mainly by the carrier unit 21 as an example of the ground transport vehicle 2. The ground transport vehicle 2 has, inside the carrier unit 21, a power storage device 22, a motor 24 for driving wheels 25, and a motor control device 23 for driving and controlling the motor 24. The power storage device 22 is a secondary battery such as a lithium battery. The ground transport vehicle 2 includes a non-contact power receiving device, a charging circuit, and the like (not shown). A charging spot for charging the power storage device 22 is provided along the travel path of the ground transport vehicle 2 or at a position away from the travel path. When the ground transport vehicle 2 stops at the charging spot, electric power is supplied to the ground transport vehicle 2 through electromagnetic induction. Needless to say, the charging method is not limited to this type of non-contact power supply method, and electric power may alternatively be supplied to the power storage device 22 through a wired connection at the charging spot.

The carrier unit 21 has, on its upper surface, a placement section 21a on which the article W is placed. For example, in the case where an engaging recess or the like is formed in the bottom of the article W, the placement section 21a may be provided with an engaging protrusion engageable with the engaging recess, thereby facilitating positioning when the article W is transferred to the placement section 21a and when the article W is taken out from the placement section 21a. Also, installation of a transfer machine such as a robot arm for transferring the article W on the carrier unit 21 is not interrupted.

The ground transport vehicle 2 can travel on the floor surface 200 without traveling on a track such as the travel rails 11 for the overhead transport vehicle 1. However, even though no track is provided, a travel path may be defined. Fine broken lines shown in FIG. 1 indicate the travel path (ground travel path 20) for the ground transport vehicle 2. For example, reference indicators M (reference indexes) are installed on the floor surface 200. The ground transport vehicle 2 includes a sensor 29 capable of acquiring position information held by the reference indicators M. The reference indicators M may be, for example, magnetic media such as magnetic tape or magnetic markers, indicators such as bar codes or marks, or non-contact electromagnetic media such as IC tags. When the reference indicators M are magnetic media, it is preferable that the sensor 29 is a magnetic sensor such as a magnetic induction sensor or a magnetic mark sensor. When the reference indicators M are indicators, it is preferable that the sensor 29 is constituted by a camera and an image processing device. For example, a bar code reader can be applied as the sensor 29. Further, when the reference indicators M are non-contact electromagnetic media, the sensor 29 may be a tag reader capable of reading information held by the non-contact electromagnetic media.

The present embodiment illustrates a mode in which the reference indicators M include general indicators M1 and stop indicators M2. The ground transport vehicle 2 can travel autonomously. The ground transport vehicle 2 can travel autonomously while specifying its own position, for example, by Light Detection and Ranging (LiDAR) using an optical sensor such as a laser diode. Further, the position of the vehicle may also be estimated in an auxiliary manner based on the rotational speed of the motor 24, the rotational speed of the wheels 25, the steering angle of the wheels 25, and the like. A mode may also be adopted in which magnetic tape or the like is laid on the floor surface along the travel path, and the ground transport vehicle 2 travels along the magnetic tape while using a magnetic sensor such as a magnetic induction sensor.

Here, it is possible that, as the travel distance of the ground transport vehicle 2 increases, errors accumulate and cause a positional deviation. It is therefore preferable to correct the position of the vehicle based on the reference indicators M. The general indicators M1 are reference indicators M for thus correcting the position of the vehicle. The general indicators M1 are provided at some portions of the ground travel path 20 with a lower density than the stop indicators M2, which will be described later. There are cases where the ground transport vehicle 2 transfers the article W to and from the overhead transport vehicle 1, as mentioned above. In such cases, it is preferable that the stop position of the ground transport vehicle 2 is controlled with high accuracy. The stop indicators M2 are arranged such that the ground transport vehicle 2 can stop at a specified stop position with high accuracy.

Thus, as one aspect, the ground transport vehicle 2 is capable of traveling on the floor surface 200 without a track and detecting the reference indicators M disposed around the ground travel path 20. Considering, for example, detecting the reference indicators M using a camera and an image processing device, the reference indicators M need not necessarily be disposed on the ground travel path 20. The reference indicators M may be disposed on a column present along the travel path, the ceiling, the lower surfaces of the travel rails 11 for the overhead transport vehicle 1, and/or various processing devices (described later) for producing semiconductor products. Note that, regardless of the presence or absence of the reference indicators M, the positioning may be performed by recognizing the overhead transport vehicle 1 with use of, for example, a camera and an image processing device mounted on the ground transport vehicle 2. For example, the stop position of the ground transport vehicle 2 may be determined by recognizing the overhead transport vehicle 1 to which the article W is to be transferred.

The ground transport vehicle 2 can identify its own position by detecting a reference indicator M disposed around the ground travel path 20 with use of the sensor 29. Also, the ground transport vehicle 2 can travel autonomously while estimating its own position as mentioned above. The ground transport vehicle 2 may also travel along a free path without traveling along the defined ground travel path 20. Here, it is desirable that the position where the ground transport vehicle 2 stops to transfer the article W to and from the overhead transport vehicle 1 is highly accurate. Accordingly, it is preferable that the reference indicators M are installed at least at positions corresponding to transfer positions P where the article W is transferred between the overhead transport vehicle 1 and the ground transport vehicle 2. Specifically, it is preferable that the reference indicators M include at least the stop indicators M2.

Here, the “positions corresponding to the transfer positions P” need not necessarily be positions on the ground travel path 20. As mentioned above, the reference indicators M need not necessarily be disposed on the ground travel path 20, and may also be disposed on a column, the ceiling, the lower surfaces of the travel rails 11 for the overhead transport vehicle 1, and/or various processing devices. Accordingly, the stop indicators M2 included in the reference indicators M may also be similarly disposed on a column, the ceiling, the lower surfaces of the travel rail 11 for the overhead transport vehicle 1, and/or various processing devices. It is preferable that the reference indicators M (stop indicators M2) are installed at least at positions each specifying the transfer position P where the article W is transferred between the overhead transport vehicle 1 and the ground transport vehicle 2. That is, the reference indicators M (stop indicators M2) need only be disposed at positions at each of which the ground transport vehicle 2 can specify the transfer position P so as to be able to stop at the transfer position P.

As shown in FIG. 5, the inter-floor transport device 3 includes a lift 31 and entry-exit sections 32. Each entry-exit section 32 is constituted by, for example, a conveyor. The inter-floor transport device 3 is a transport device for transporting the article W along a transport path 30 (see FIG. 5), which is different from transport paths of the overhead transport vehicle 1 and the ground transport vehicle 2. The ground transport vehicle 2 transports the article W in the horizontal direction. The overhead transport vehicle 1 transports the article W in the horizontal direction and moves the article W in the vertical direction (up-down direction V) when transferring it. The inter-floor transport device 3 is a transport device that transports the article W at least in the up-down direction V. The overhead transport vehicle 1 and the ground transport vehicle 2 transport the article W in a space between one ceiling 100 and one floor surface 200, that is, in each of a space (first-floor space) between a first ceiling 101 and a first floor surface 201 and a space (second-floor space) between a second ceiling 102 and a second floor surface 202. On the other hand, the inter-floor transport device 3 moves through the first ceiling 101 and the second floor surface 202 and transports the article W between the first-floor space and the second-floor space.

Although the present embodiment illustrates the inter-floor transport device 3 as the third automatic transport machine, the third automatic transport machine (transport device) may alternatively be an automated warehouse equipped with a stacker crane or the like, or the stacker crane in this automated warehouse. Further, in the case where the article W is an FOUP as in the present embodiment, the transport facility 4 may be provided in a semiconductor manufacturing facility. In this case, the third automatic transport machine (transport device) may be a transport mechanism for moving the article W that is provided in various processing devices for performing various types of processing on semiconductor wafers to produce semiconductor products.

Each entry-exit section 32 of the inter-floor transport device 3 corresponds to the transfer section 5 where the article W is transferred between the overhead transport vehicle 1 and the inter-floor transport device 3. The entry-exit section 32 is located on the upper side V1 of the floor surface 200 and is separated from the floor surface 200, as shown in FIG. 5. The article W is not directly transferred between the entry-exit section 32 and the ground transport vehicle 2, but is transferred via the overhead transport vehicle 1. For this reason, the entry-exit section 32 in the present embodiment can be located at a height that at least allows the ground transport vehicle 2 with the article W placed thereon to travel on the lower side V2 of the transfer section 5. In the case where the third automatic transport machine is an automated warehouse equipped with a stacker crane, or a transport mechanism provided in various processing devices for producing semiconductor products, similarly, the floor surface 200 can be effectively utilized since the transfer section 5 is located on the upper side V1 of the floor surface 200 and is separated from the floor surface 200.

While the overhead transport vehicle 1 and the ground transport vehicle 2 are aligned in the up-down direction V as shown in FIG. 4, the article W can be transferred between the overhead transport vehicle 1 and the ground transport vehicle 2 by the overhead transport vehicle 1 moving the article W up and down. Specifically, while the overhead transport vehicle 1 and the ground transport vehicle 2 are aligned in the up-down direction V, the overhead transport vehicle 1 can transfer the article W to the ground transport vehicle 2 by lowering the article holder 18 while gripping the article W with the gripper 19. Also, while the overhead transport vehicle 1 and the ground transport vehicle 2 are aligned in the up-down direction V, the overhead transport vehicle 1 can transfer the article W from the ground transport vehicle 2 by lowering the article holder 18, gripping the article W placed on the ground transport vehicle 2 with use of the gripper 19, and then moving the article holder 18 upward.

Note that the ground transport vehicle 2 may also include a mechanism capable of moving the placement section 21a up and down. Thus, the configuration for transferring the article W between the overhead transport vehicle 1 and the ground transport vehicle 2 is not impeded by moving the placement section 21a of the ground transport vehicle 2 up and down without the article holder 18 of the overhead transport vehicle 1 moving up and down. Needless to say, the configuration for transferring the article W between the overhead transport vehicle 1 and the ground transport vehicle 2 is not impeded either by both the article holder 18 of the overhead transport vehicle 1 and the placement section 21a of the ground transport vehicle 2 moving up and down.

Note that the overhead transport vehicle 1 can not only move the article holder 18 up and down immediately below the travel unit 12, but also move the article W up and down while sliding the article holder 18 in a path width direction H relative to the travel unit 12, as shown in FIG. 4. A sliding path 10h along which the article holder 18 slides also corresponds to a movement trajectory of the article W.

The overhead transport vehicle 1 and the ground transport vehicle 2 transfer the article W to each other by moving the article W up and down, while the overhead transport vehicle 1 and the ground transport vehicle 2 are aligned in the up-down direction V. In other words, the overhead transport vehicle 1 and the ground transport vehicle 2 transfer the article W to each other by moving the article W up and down with the article holder 18 and the placement section 21a aligned in the up-down direction V. The state where “the overhead transport vehicle 1 and the ground transport vehicle 2 are aligned in the up-down direction V” is not limited to the case where the article holder 18 is located below the travel rails 11 (i.e., immediately below the travel section 12) as shown in FIG. 4, but also includes a state where the article holder 18 has slid in the path width direction H (not shown). In the state where the article holder 18 has slid in the path width direction H, the article W can also be transferred between the overhead transport vehicle 1 and the ground transport vehicle 2 by moving the article W up and down with the article holder 18 and the placement section 21a of the ground transport vehicle 2 aligned in the up-down direction V.

To transfer the article W between the overhead transport vehicle 1 and the ground transport vehicle 2, the movement trajectory of the article W (overhead travel path 10, slide path 10h) moved by the overhead transport vehicle 1 overlaps the travel trajectory (ground travel path 20) of the ground transport vehicle 2, as viewed in the up-down direction, at a position where the article holder 18 moves up and down. Accordingly, the travel rails 11 (track) are disposed such that there are some locations where the movement trajectory of the article W moved by the overhead transport vehicle 1 overlaps the ground travel path 20 as viewed in the up-down direction. A section of the travel rails 11 that includes such an overlap location is referred to as an overlap section.

Although the travel rails 11 need not necessarily be parallel to the ground travel path 20 in the overlap section, FIG. 1 illustrates a mode in which the travel rails 11 (overhead travel path 10) are parallel to the ground travel path 20. In the example shown in FIG. 1, the overlap section corresponds to each section of the travel rails 11 where the overhead travel path 10 indicated by a thick broken line overlaps the ground travel path 20 indicated by a thin broken line. Although the broken line representing the overhead travel path 10 is shifted from the broken line representing the ground travel path 20 in FIG. 1 for clarity, it is preferable that the overhead travel path 10 overlaps the ground travel path 20 as viewed in the up-down direction.

The transport facility 4 in this embodiment also includes the storage device 6 supported by the ceiling 100 and disposed along the travel rails 11 to store the article W, as shown in FIG. 4. The storage device 6 is, for example, a storage installed on the ceiling side. The storage device 6 is disposed such that its lowermost portion (portion on the lower side V2) is located on the upper side V1 of the floor surface 200 and is separated from the floor surface 200. That is, similar to the transfer section 5, the storage device 6 is located at a height that at least allows the ground transport vehicle 2 with the article W placed thereon to travel on the lower side V2 of the transfer section 5. The article holder 18 of the overhead transport vehicle 1 is slidable along the path width direction H as mentioned above, and the overhead transport vehicle 1 enables the transfer of the article W between the overhead transport vehicle 1 and the storage device 6 by sliding the article holder 18 toward the storage device 6 along the path width direction H. That is, the article W can be directly transferred between the overhead transport vehicle 1 and the storage device 6. Similar to the transfer between the ground transport vehicle 2 and the inter-floor transport device 3, the article W can be transferred between the ground transport vehicle 2 and the storage device 6 via the overhead transport vehicle 1.

Note that, regardless of whether the overhead transport vehicle 1 can slide the article holder 18, the storage device 6 may include a transfer machine that enables the transfer of the article W between the storage device 6 and the overhead transport vehicle 1 (e.g., a fork capable of moving back and forth along the path width direction H, a conveyor extending in the path width direction H etc.). This transfer machine may be used to transfer the article W between the overhead transport vehicle 1 and the storage device 6.

It is preferable that the storage device 6 can store a plurality of articles W. The storage device 6 can function as a buffer for temporarily storing the articles W transported on one floor by the overhead transport vehicle 1 and the ground transport vehicle 2. The storage device 6 functioning as a buffer can reduce the time required for transport to a destination and makes it easy to increase transport efficiency. The storage device 6 includes a plurality of holders 61 for storing the plurality of articles W. The article W can be directly transferred between the storage device 6 and the overhead transport vehicle 1, as mentioned above. It is therefore preferable that the plurality of holders 61 are arranged side by side along the overhead travel path 10 (the travel rails 11), as shown in FIG. 1. Further, considering that the article W is transferred between the storage device 6 and the ground transport vehicle 2 via the overhead transport vehicle 1, it is preferable, in terms of the relationship with the ground travel path 20, that the plurality of holders 61 are also arranged side by side along the ground travel path 20, as shown in FIG. 1.

That is, the travel rails 11 have parallel sections, which are parallel to the ground travel path 20 serving as the travel trajectory of the ground transport vehicle 2, as shown in FIG. 1. The plurality of holders 61, each of which can store the article W, are arranged side by side along the parallel sections. The storage device 6 includes the above-described holders 61.

Note that the transport efficiency is expected to increase by temporarily storing the article W transported by the overhead transport vehicle 1. Thus, the storage device 6 may alternatively have a configuration in which the holders 61 are not arranged side by side along the parallel sections. That is, the storage device 6 may be located at any position relative to the travel rails 11, and may be located not only in the parallel sections but also in a section that is not an overlap section either.

The above-described transport facility is briefly summarized below.

As one aspect, a transport facility includes: an overhead transport vehicle configured to travel on a track held by a ceiling of the transport facility and transport an article; a ground transport vehicle configured to travel on a floor surface and transport an article; a transport device configured to transport an article along a transport path different from a transport path of the overhead transport vehicle and from a transport path of the ground transport vehicle; and a transfer section for an article to be transferred between the overhead transport vehicle and the transport device, the transfer section being above the floor surface and separated from the floor surface, the overhead transport vehicle and the ground transport vehicle being configured to directly transfer an article therebetween, the ground transport vehicle and the transport device being configured to transfer an article therebetween via the overhead transport vehicle and the transfer section.

According to this configuration, the article can be transferred between the overhead transport vehicle and the ground transport vehicle, not via the transfer section. This eliminates the need for providing a transfer section on the floor surface. The transfer section is used to transfer the article between the overhead transport vehicle and the transport device. Here, the transfer section is disposed above the floor surface and is separated therefrom, so that it is not necessary to secure a space for providing a transfer section on the floor surface.

It is preferable that the overhead transport vehicle and the ground transport vehicle are configured to be aligned with each other vertically and raise and lower an article to transfer the article, and the track has a overlap section in which the overhead transport vehicle moves an article along a trajectory that coincides with a travel trajectory of the ground transport vehicle as viewed vertically.

According to this configuration, the article can be transferred properly between the ground transport vehicle and the overhead transport vehicle while the overhead transport vehicle is located in the overlap section where the movement trajectory overlaps the travel trajectory as viewed in the up-down direction, and while the ground transport vehicle and the overhead transport vehicle are aligned in the up-down direction.

It is preferable that the transport facility further includes a storage device held by the ceiling, disposed along the track, and configured to store an article, wherein the overhead transport vehicle and the storage device are configured to directly transfer an article therebetween, and the ground transport vehicle and the storage device are configured to transfer an article therebetween via the overhead transport vehicle.

According to this configuration, not only the article transported by the overhead transport vehicle but also the article transported by the ground transport vehicle can be stored in the storage device supported by the ceiling. Accordingly, the utilization efficiency of the floor surface can be increased more easily than in the case where a storage device for storing the article transported by the ground transport vehicle is provided separately.

It is preferable that the overhead transport vehicle and the ground transport vehicle are configured to be aligned with each other vertically and raise and lower an article to transfer the article, the track has a parallel section that is parallel to a travel trajectory of the ground transport vehicle, and the storage device includes a plurality of holders arranged along the parallel section and each configured to store an article.

According to this configuration, it is easy to reduce the distance that the article is to move in the case where the article is supplied from the storage device to the ground transport vehicle via the overhead transport vehicle and in the case where the storage device receives the article from the ground transport vehicle via the overhead transport vehicle. Therefore, the article transport efficiency can be easily increased. Further, the storage device including the plurality of holders arranged along the parallel section makes it easy to set a plurality of locations for transferring the article between the overhead transport vehicle and the ground transport vehicle in the case of transferring the article between the ground transport vehicle and the storage device via the overhead transport vehicle, and also makes it easy to improve convenience of article transfer operations.

It is preferable that the ground transport vehicle is configured to travel on the floor surface without a track and to detect a reference indicator disposed near a travel path of the ground transport vehicle, and the reference indicator at least so positioned as to specify a transfer position at which the overhead transport vehicle and the ground transport vehicle transfer an article therebetween.

According to this configuration, positional accuracy can be easily increased in the case of stopping the ground transport vehicle at a location for transferring the article between the overhead transport vehicle and the ground transport vehicle, making it easy to properly transfer the article.

What is claimed is:

1. A transport facility comprising:
an overhead transport vehicle configured to travel on a track held by a ceiling of the transport facility and transport an article;
a ground transport vehicle configured to travel on a floor surface and transport an article;
a transport device configured to transport an article along a transport path different from a transport path of the overhead transport vehicle and from a transport path of the ground transport vehicle; and
wherein:
a transfer section for an article to be transferred between the overhead transport vehicle and the transport device, the delivery section is above the floor surface and separated from the floor surface,
the overhead transport vehicle and the ground transport vehicle are configured to directly transfer an article therebetween,
the ground transport vehicle and the transport device are configured to transfer an article therebetween via the overhead transport vehicle and the transfer section.

2. The transport facility according to claim 1,
wherein the overhead transport vehicle and the ground transport vehicle are configured to be aligned with each other vertically and raise and lower an article to transfer the article, and
wherein the track has an overlap section where the overhead transport vehicle moves an article along a trajectory that coincides with a travel trajectory of the ground transport vehicle as viewed vertically.

3. The transport facility according to claim 1, further comprising:
a storage device held by the ceiling, disposed along the track, and configured to store an article,
wherein the overhead transport vehicle and the storage device are configured to directly transfer an article therebetween, and
wherein the ground transport vehicle and the storage device are configured to transfer an article therebetween via the overhead transport vehicle.

4. The transport facility according to claim 3,
wherein the overhead transport vehicle and the ground transport vehicle are configured to be aligned with each other vertically and raise and lower an article to transfer the article,
wherein the track has a parallel section that is parallel to a travel trajectory of the ground transport vehicle, and
wherein the storage device comprises a plurality of holders arranged along the parallel section and each configured to store an article.

5. The transport facility according to claim 1,
wherein the ground transport vehicle is configured to travel on the floor surface without a track and to detect a reference indicator disposed near a travel path of the ground transport vehicle, and
wherein the reference indicator at least so positioned as to specify a transfer position at which the overhead transport vehicle and the ground transport vehicle transfer an article therebetween.
